(19) United States
(12) Patent Application Publication
(10) Pub. No.: US 2025/0313354 A1
(43) Pub. Date: Oct. 9, 2025

(54) UNMANNED AIRCRAFT

(71) Applicant: Kubota Corporation, Osaka (JP)

(72) Inventor: Kohei SEINO, Sakai-shi (JP)

(21) Appl. No.: 19/246,738

(22) Filed: Jun. 24, 2025

Related U.S. Application Data
(63) Continuation of application No. PCT/JP2022/048157, filed on Dec. 27, 2022.

(51) Int. Cl. B64U 10/14; B64D 1/02; B64D 17/00; B64D 25/00; B64U 101/40; B64U 101/69; G05D 1/656; G05D 109/25

(52) U.S. Cl. CPC B64U 10/14; B64D 1/02; B64D 17/00; B64D 25/00; G05D 1/665; B64U 2101/40; B64U 2101/69; B64U 2201/00; G05D 2109/254

(57) ABSTRACT

An unmanned aerial vehicle includes a plurality of rotors, the unmanned aerial vehicle being capable of flying with a ground work machine connected to a body. The unmanned aerial vehicle includes a controller configured or programmed to control flight of the unmanned aerial vehicle, at least one parachute connected to the body or the ground work machine, and at least one airbag provided on the body or the ground work machine.

### CROSS REFERENCE TO RELATED APPLICATIONS

This application claims the benefit of priority to Continuation Application of PCT Application No. PCT/JP2022/048157 filed on Dec. 27, 2022. The entire contents of this application are hereby incorporated herein by reference.

### BACKGROUND OF THE INVENTION

### 1. Field of the Invention

The present disclosure relates to unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Document 1 Application Publication No. 2022-104737 describes an unmanned aerial vehicle (unmanned flying body) that changes its flight position in coordination with the operation of an agricultural machine.

### SUMMARY OF THE INVENTION

There is a demand for an unmanned aerial vehicle capable of flying with a ground work machine connected to its body.

Example embodiments of the present disclosure provide unmanned aerial vehicles capable of flying with ground work machine connected to its body.

In a non-limiting example embodiment, an unmanned aerial vehicle of the present disclosure includes a plurality of rotors to cause the unmanned aerial vehicle to fly with a ground work machine connected to a body, a controller configured or programmed to control flight of the unmanned aerial vehicle, at least one parachute connected to the body or the ground work machine, and at least one airbag provided on the body or the ground work machine.

In a non-limiting example embodiment, an unmanned aerial vehicle of the present disclosure includes a plurality of rotors to cause the unmanned aerial vehicle to fly with a ground work machine connected to a body, a controller configured or programmed to control flight of the unmanned aerial vehicle, wherein the controller is configured or programmed to release a connection between the ground work machine and the body when detecting an abnormality of the plurality of rotors during flight.

According to example embodiments of the present disclosure, unmanned aerial vehicles each capable of flying with a ground work machine connected to its body is provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3A is a block diagram showing an example of a configuration of a multicopter.

FIG. 3B is a block diagram showing an example of a configuration of a multicopter.

FIG. 3C is a diagram schematically showing an example of a connection mechanism of a multicopter.

FIG. 4A is a flowchart showing an example of an operation of a controller according to the present example embodiment of the present invention.

FIG. 4B is a flowchart showing an example of an operation of a controller according to the present example embodiment of the present invention.

FIG. 4C is a flowchart showing an example of an operation of a controller according to the present example embodiment of the present invention.

FIG. 5 is a plan view schematically showing a flight path of a multicopter.

FIG. 6A is a diagram schematically showing how a multicopter, which is flying with an implement connected to its body, releases a connection between the implement and the body during flight.

FIG. 6B is a diagram schematically showing how a multicopter, which is flying with an implement connected to its body, releases a connection between the implement and the body during flight.

FIG. 6C is a diagram schematically showing how a multicopter, which is flying with an implement connected to its body, releases a connection between the implement and the body during flight.

FIG. 6D is a diagram schematically showing how a multicopter, which is flying with an implement connected to its body, releases a connection between the implement and the body during flight.

FIG. 6E is a diagram schematically showing how a multicopter, which is flying with an implement connected to its body, releases a connection between the implement and the body during flight.

FIG. 6F is a diagram schematically showing how a multicopter, which is flying with an implement connected to its body, releases a connection between the implement and the body during flight.

FIG. 7A is a perspective view schematically showing an example of a basic configuration of a multicopter.

FIG. 7B is a perspective view schematically showing an example of a basic configuration of a multicopter.

FIG. 8 is a block diagram showing an example of hardware configuration of the controller in the present example embodiment of the present invention.

FIG. 9 is a schematic diagram showing a configuration example of a system including a multicopter.

### DETAILED DESCRIPTION OF THE EXAMPLE EMBODIMENTS

An unmanned aerial vehicle including a plurality of rotors includes a rotation driver that rotates the rotors (hereinafter referred to as “propellers”). Hereinafter, such an unmanned aerial vehicle is referred to as a “multicopter”.

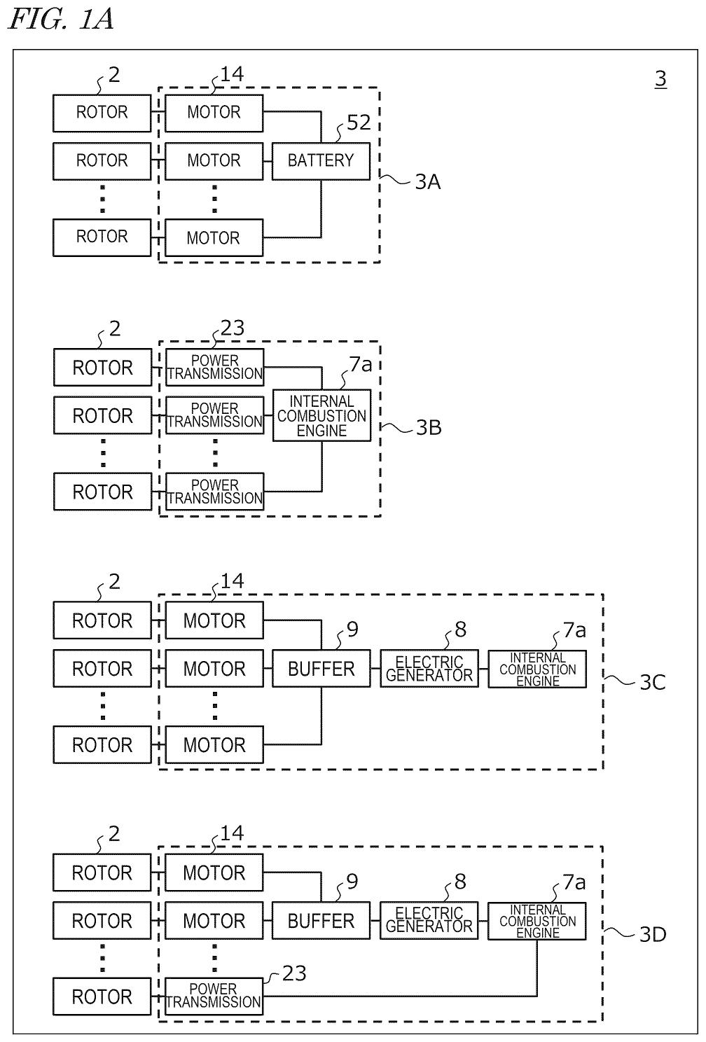

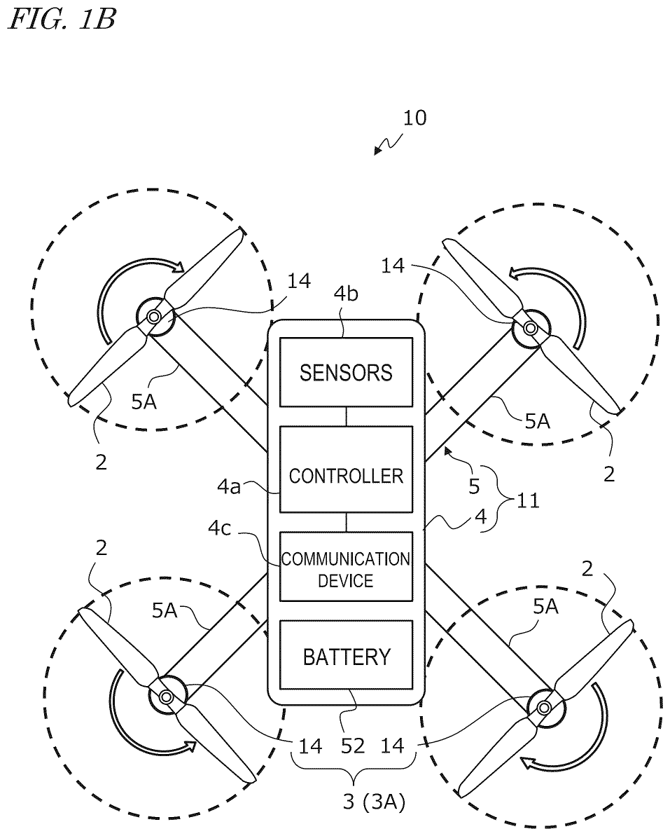

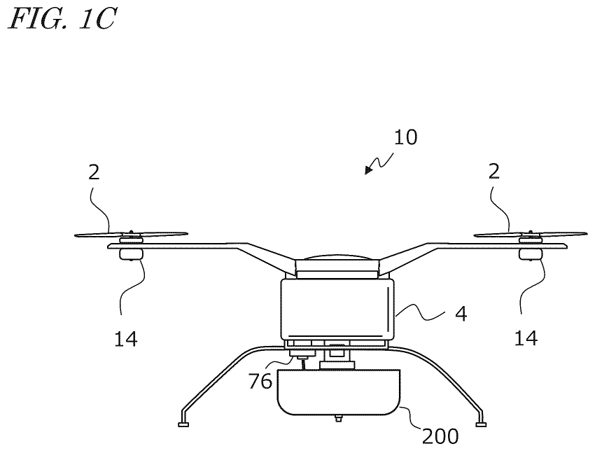

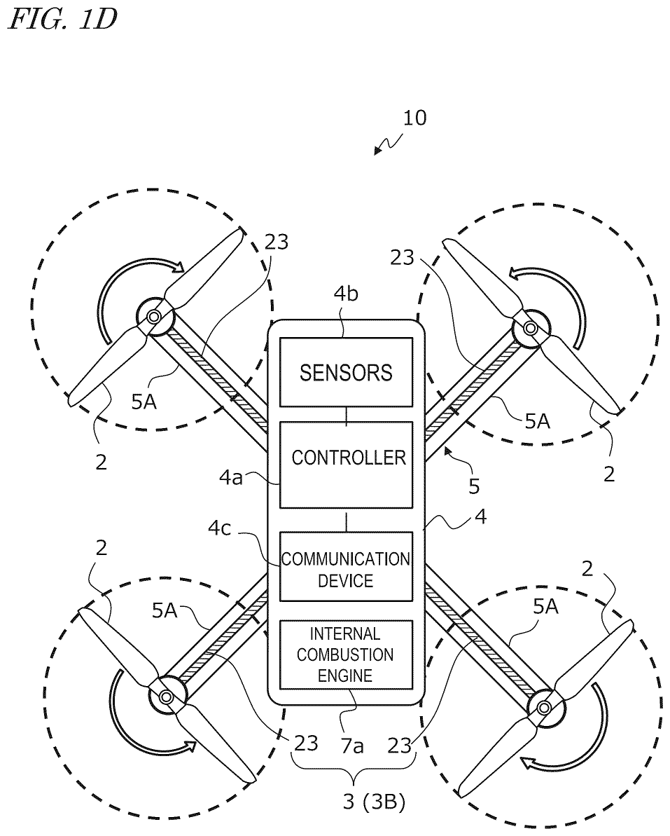

The configuration of rotation drivers included in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of drive is called “series hybrid driver”. The electric generator 8 and internal combustion engine 7a in series hybrid drive are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a is configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute part or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust. Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are equipped, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned more inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism to change the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used for both generating thrust and attitude control. The main rotors may be called “booster rotors” and the sub-rotors may be called “attitude control rotors”.

In the parallel hybrid driver, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt parallel hybrid drive or series hybrid drive to increase payload and flight duration. Note that when the rotation driver 3 includes a mechanism to change the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 is a device that supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery for storing power.

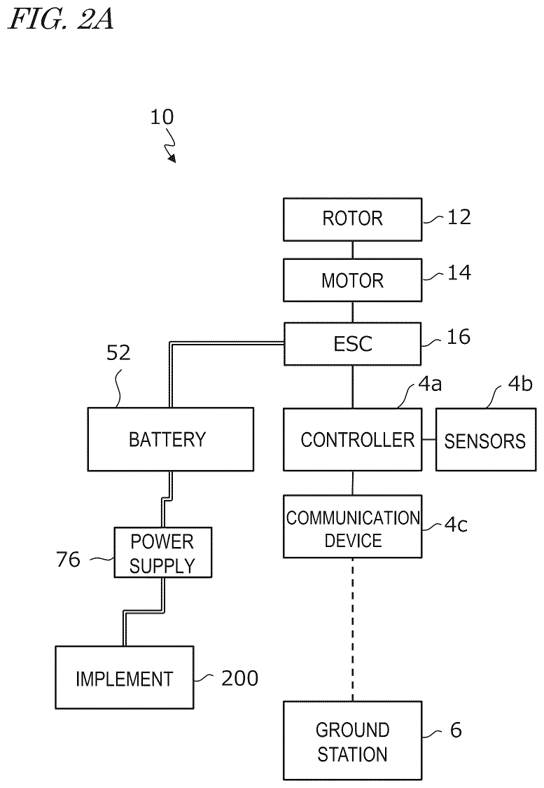

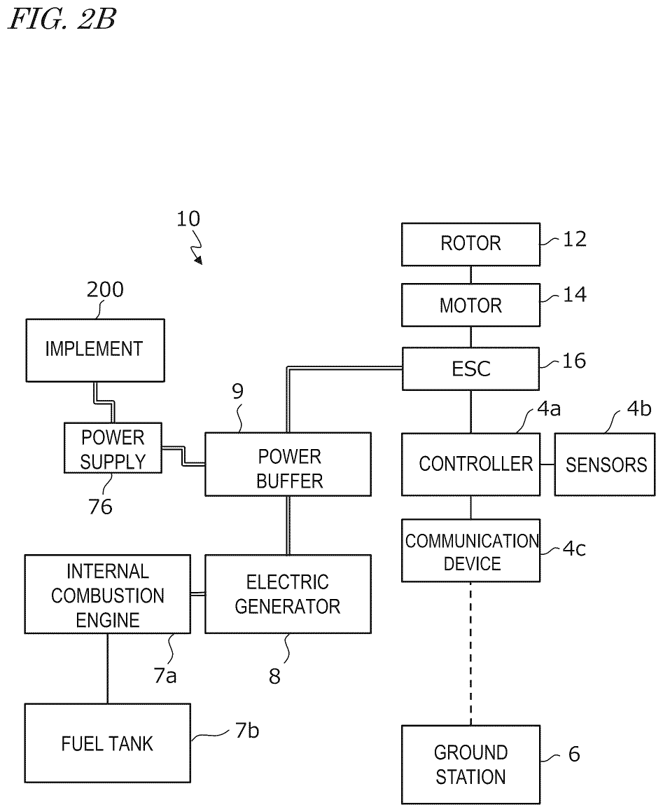

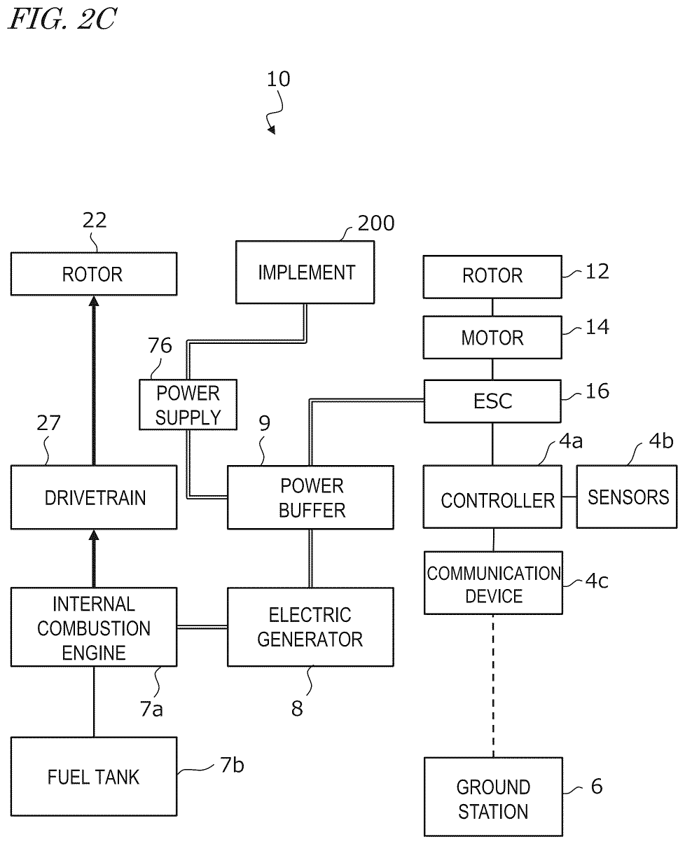

FIG. 2A shows a block diagram of a basic configuration example of a battery-driven multicopter 10.

The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's controller on the ground. The controller 4a may be configured or programmed to function to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless means.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits driving force from the internal combustion engine 7a, and the rotor 22 that rotates upon the receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

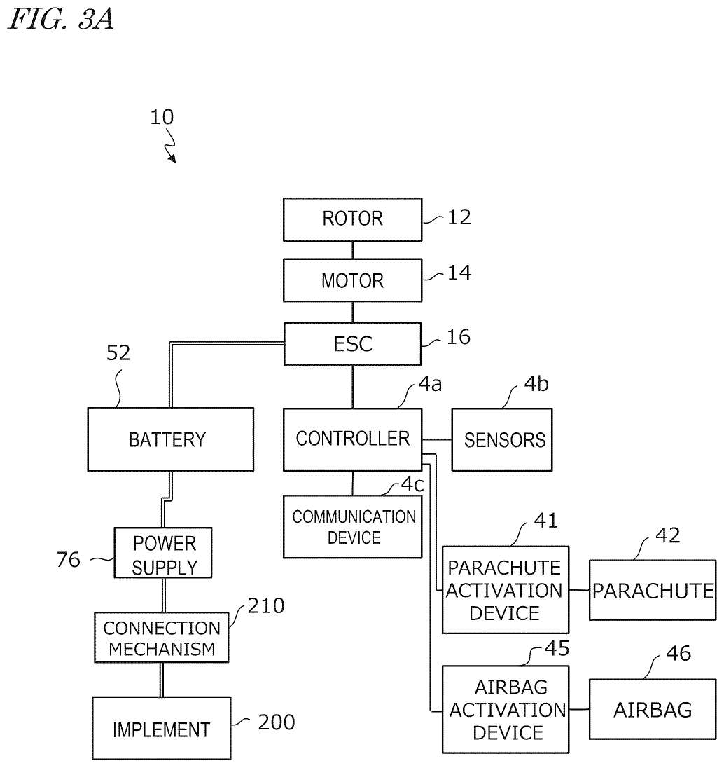

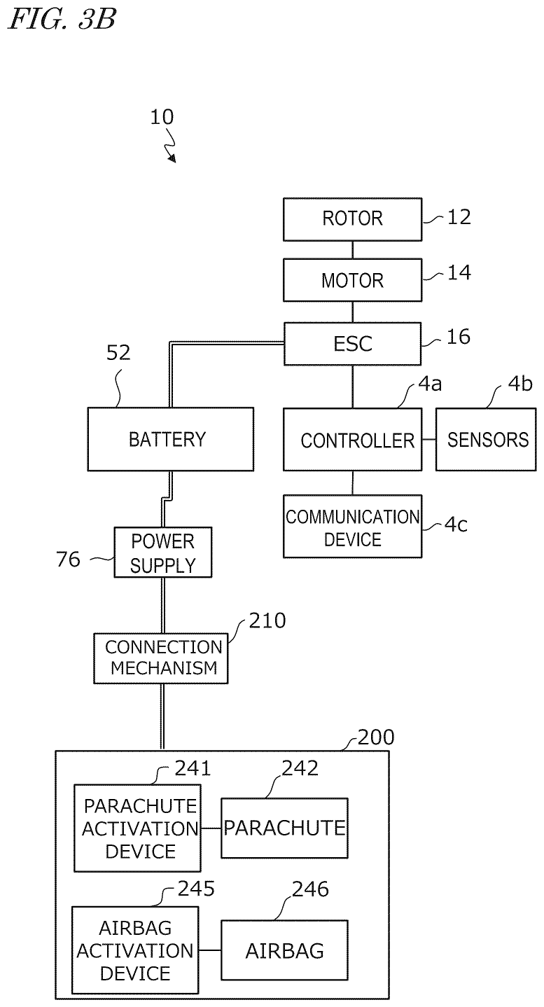

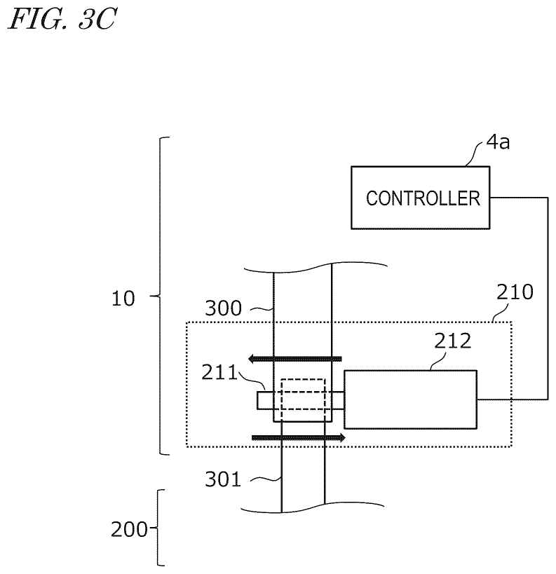

FIGS. 3A and 3B show block diagrams illustrating examples of the configuration of an unmanned aerial vehicle (multicopter) according to an example embodiment of the present disclosure. The unmanned aerial vehicle (multicopter) and the control system and control method for controlling the flight of the unmanned aerial vehicle (multicopter) according to an example embodiment of the present disclosure will be explained with reference to FIGS. 3A and 3B.

FIG. 3A is a block diagram showing an example of the configuration of a battery-driven multicopter 10. The configuration shown in FIG. 3A includes, in addition to the configuration of the battery-driven multicopter 10 shown in FIG. 2A, a parachute 42 connected to the body 11 and an airbag 46 provided on the body 11. The multicopter 10 shown in FIG. 3A is capable of flying with an implement 200 connected to the body 11 (or main body 4), as shown in the example of FIG. 1C. The multicopter 10 shown in FIG. 3A further includes a parachute activation device 41 that activates (deploys) the parachute 42 and an airbag activation device 45 that activates the airbag 46. The parachute activation device 41 and the airbag activation device 45 are each independently connected to the controller 4a. The controller 4a is configured or programmed to control the activation (deployment) of the parachute 42 by providing a signal to control the activation (deployment) of the parachute 42 to the parachute activation device 41. The controller 4a is configured or programmed to control the activation of the airbag 46 by providing a signal to control the activation of the airbag 46 to the airbag activation device 45. The multicopter 10 shown in FIG. 3A further includes a connection mechanism 210 that connects the body 11 (or main body 4) and the implement 200.

FIG. 3B is a block diagram showing another example of the configuration of a battery-driven multicopter 10. The configuration shown in FIG. 3B includes, in addition to the configuration of the battery-driven multicopter 10 shown in FIG. 2A, a parachute 242 connected to the implement 200 and an airbag 246 provided on the implement 200. The multicopter 10 shown in FIG. 3B is capable of flying with an implement 200 connected to the body 11 (or main body 4), as shown in the example of FIG. 1C. The multicopter 10 shown in FIG. 3B further includes a parachute activation device 241 that activates (deploys) the parachute 242 and an airbag activation device 245 that activates the airbag 246. The controller 4a communicates with the implement 200 connected to the power supply 76. The controller 4a is configured or programmed to control the activation (deployment) of the parachute 242 by providing a signal to control the activation (deployment) of the parachute 242 to the parachute activation device 241. The controller 4a is configured or programmed to control the activation of the airbag 246 by providing a signal to control the activation of the airbag 246 to the airbag activation device 245. The communication between the controller 4a and the implement 200 may be conducted through wired or wireless means. The multicopter 10 shown in FIG. 3B further includes a connection mechanism 210 that connects the body 11 (or main body 4) and the implement 200.

FIG. 3C is a diagram schematically showing an example of the configuration of the connection mechanism 210 included in the multicopter 10. As shown in FIG. 3C, the connection mechanism 210 is a structure that connects a frame 300 fixed to the body 11 (or main body 4) and a frame 301 included in the implement 200. The connection mechanism 210 includes a connection pin (connector) 211 and an actuator 212 that moves the connection pin 211. In a state (connected state) where the multicopter 10 and the implement 200 are connected, the connection pin 211 is inserted into a hole formed in the frame 300 and a hole formed in the frame 301, thereby connecting the frame 300 and the frame 301. In a state (released state) where the connection between the multicopter 10 and the implement 200 is released, the connection pin 211 is removed from (taken out of) the hole formed in the frame 300 and the hole formed in the frame 301, thereby releasing the connection between the frame 300 and the frame 301.

The actuator 212 is, for example, a solenoid or the like that moves the connection pin (connector) 211 in a horizontal direction (in the direction of the arrow in FIG. 3C). In the connected state, the actuator 212 maintains the connection pin (connector) 211 in a state where it is inserted into the respective holes of the frames 300 and 301, and in the released state, the actuator 212 maintains the connection pin (connector) 211 in a state where it is separated from (taken out of) the respective holes of the frames 300 and 301. The controller 4a switches between the connected state and the released state by controlling the operation of the connection mechanism 210 (actuator 212). When switching from the connected state to the separated state, the controller 4a outputs a control signal to the actuator 212 to move the connection pin (connector) 211 in a direction to be separated from the respective holes of the frames 300 and 301. When switching from the separated state to the connected state, the controller 4a outputs a control signal to the actuator 212 to move the connection pin (connector) 211 in a direction to be inserted into the respective holes of the frames 300 and 301. The configuration of the connection mechanism 210 described above is merely an example and is not limited to the illustrated example. The connection mechanism 210 may also be applied to the configuration examples shown in FIG. 2A, 2B, or 2C.

By having the multicopter 10 include a parachute and an airbag as shown in the examples of FIGS. 3A and 3B, it is possible to prepare for the occurrence of any abnormality (for example, failure of a rotor 2, damage to a rotor 2, failure of a rotation driver that controls the rotation of a rotor 2, etc.) while flying with the implement 200 connected.

The example embodiments of the present disclosure are not limited to the illustrated examples. For example, the configuration example of FIG. 3A may be combined with the configuration example of FIG. 3B. The configuration example of FIG. 3A or FIG. 3B may also be appropriately combined with other configuration examples (for example, the configuration examples of FIGS. 2B and 2C). In the configuration examples of FIGS. 3A and 3B, one parachute and one airbag are illustrated, but each of the parachute and the airbag may be provided in plural. When a plurality of parachutes or a plurality of airbags is provided, a plurality of parachute activation devices or a plurality of airbag activation devices for controlling the activation of each parachute or airbag may be provided.

Additionally, the example embodiments of the present disclosure are not limited to the examples of FIGS. 3A and 3B, and the configuration examples of FIG. 2A, 2B, or 2C may be applied. The multicopter 10 shown in FIG. 2A, 2B, or 2C is capable of flying with an implement 200 connected to the body 11, as shown in the example of FIG. 1C, and the controller 4a can release the connection between the implement 200 and the body 11 by controlling the connection mechanism 210 when detecting an abnormality in the plurality of rotors 2 during flight. In such a case, it is also possible to prepare for the occurrence of any abnormality (for example, failure of a rotor 2, damage to a rotor 2, failure of a rotation driver that controls the rotation of a rotor 2, etc.) while flying with the implement 200 connected. The multicopter 10 shown in FIG. 2A, 2B, or 2C may further include the above-mentioned parachute and/or airbag, but the parachute and airbag are not essential.

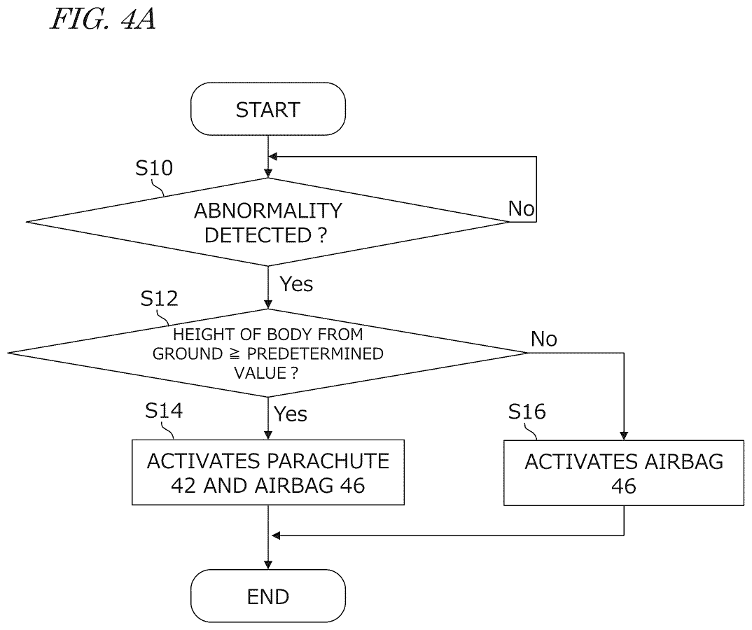

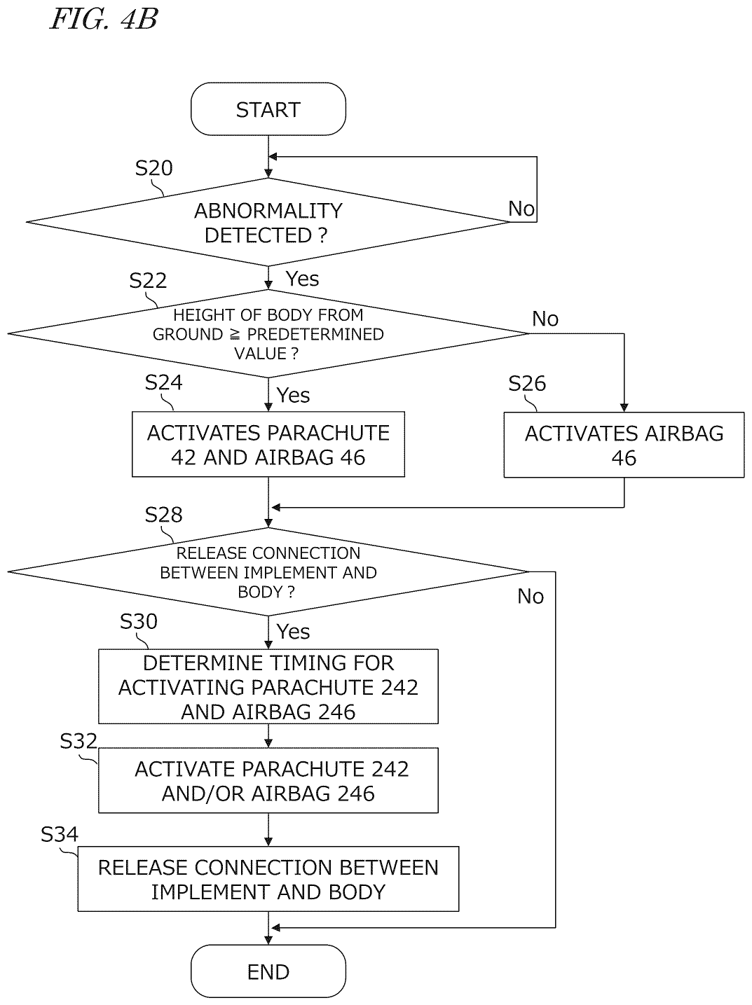

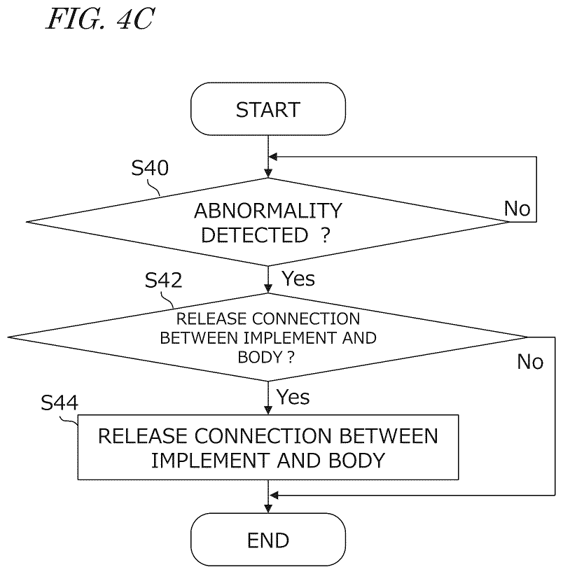

An example of the operation of the controller 4a will be explained with reference to FIG. 4A. FIG. 4A is a flowchart showing an example of the operation of the controller 4a in the case where the multicopter 10 includes a parachute 42 connected to the body 11 and an airbag 46 provided on the body 11, as shown in the configuration of FIG. 3A.

While the multicopter 10 is flying with the implement 200 connected to the body 11, the controller 4a determines at step S10 whether any abnormality (for example, failure of a rotor 2, damage to a rotor 2, failure of a rotation driver that controls the rotation of a rotor 2, etc.) has occurred. For example, the controller 4a may determine the total thrust that should be generated by the plurality of rotors 2 during flight of the multicopter 10, and determine that an abnormality has occurred when the total thrust cannot be obtained by the plurality of rotors 2.

When an abnormality is detected (in the case of “Yes”), the controller 4a determines at step S12 whether the height of the multicopter 10 from the ground (more specifically, the height of the body 11 from the ground) is equal to or greater than a predetermined value. The controller 4a can obtain information on the height of the multicopter 10 from the ground using sensor data output from an altitude sensor included in the sensor group 4b.

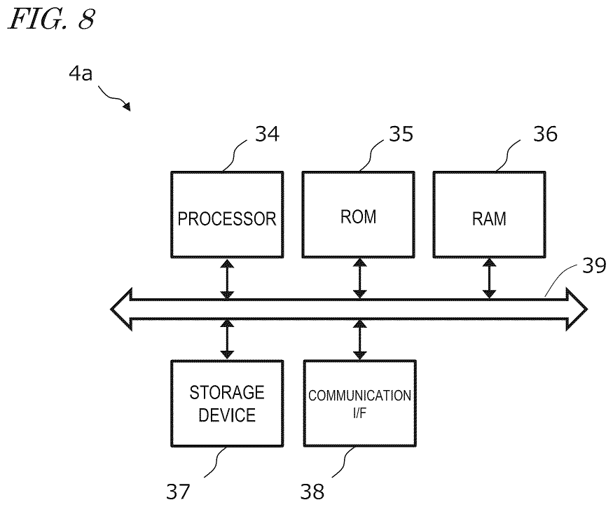

Examples of the altitude sensor include an atmospheric pressure sensor or a GNSS receiver. The altitude sensor outputs sensor data indicating the altitude of the multicopter 10. Altitude is the height from the mean sea level to a measurement point in the air. The altitude of the multicopter 10 is the height from the mean sea level to the multicopter 10, more specifically, the height from the mean sea level to the altitude sensor mounted on the multicopter 10. For example, a GNSS receiver may measure the height from the mean sea level to the multicopter 10. In this case, to obtain more accurate altitude, it is necessary to correct the measured height to the height from the geoid surface (or simply “geoid”) to the multicopter 10, taking into account the influence of gravity. Such correction processing may be performed by the GNSS receiver itself or by a processor 34 (see FIG. 8) included in the controller 4a. By combining an atmospheric pressure sensor and a GNSS receiver and complementing data with each other, it is possible to improve the accuracy of the measured altitude.

When it is determined that the height of the multicopter 10 from the ground is equal to or greater than a predetermined value, the controller 4a activates the parachute 42 and the airbag 46 at step S14. The controller 4a activates the parachute 42 and the airbag 46 by providing control signals to the parachute activation device 41 and the airbag activation device 45. The controller 4a may be configured or programmed to control the timing of activation of the parachute 42 and the airbag 46 such that the airbag 46 is activated after the parachute 42 is deployed.

When it is determined that the height of the multicopter 10 from the ground is less than the predetermined value, the controller 4a activates the airbag 46 but does not activate the parachute 42 at step S16.

Another example of the operation of the controller 4a will be explained with reference to FIG. 4B. Detailed explanations of steps common to the flowchart shown in FIG. 4A will be omitted. The flowchart of FIG. 4B shows an example of the operation of the controller 4a in the case where the multicopter 10 has a parachute 42 connected to the body 11, an airbag 46 provided on the body 11, a parachute 242 connected to the implement 200, and an airbag 246 provided on the implement 200, as shown in the configurations of FIGS. 3A and 3B. As shown in FIG. 4B, the controller 4a may release the connection between the implement 200 and the body 11 by controlling the connection mechanism 210. By releasing the connection between the implement 200 and the body 11, the total thrust that should be generated by the plurality of rotors 2 can be reduced by the weight of the implement 200.

Steps S20, S22, S24, and S26 may be performed in the same manner as steps S10, S12, S14, and S16 in FIG. 4A.

At step S28, the controller 4a determines whether to release the connection between the implement 200 and the body 11. The determination of whether to release the connection between the implement 200 and the body 11 may be made based on, for example, the flight altitude of the multicopter 10, the flight speed of the multicopter 10, the height of the implement 200 from the ground, the height of the body 11 from the ground, the type (content) of the detected abnormal condition, the remaining amount of fuel, the state of charge, the distance to an area where the implement 200 is able to be dropped, and so on. The controller 4a may also determine the position for releasing the connection between the implement 200 and the body 11 at step S28. For example, the controller 4a may decide whether to execute the release at the current position of the multicopter 10, or, if an area more suitable for dropping the implement 200 is within a reachable distance, the controller 4a may decide to move the multicopter 10 to that area and then perform the release. For example, when an abnormality of a rotor 2 is detected while the multicopter 10 is flying over a field, the controller 4a may decide to move the multicopter 10 over an area of the field where work has not yet been performed, and release the connection between the implement 200 and the body 11 over that area.

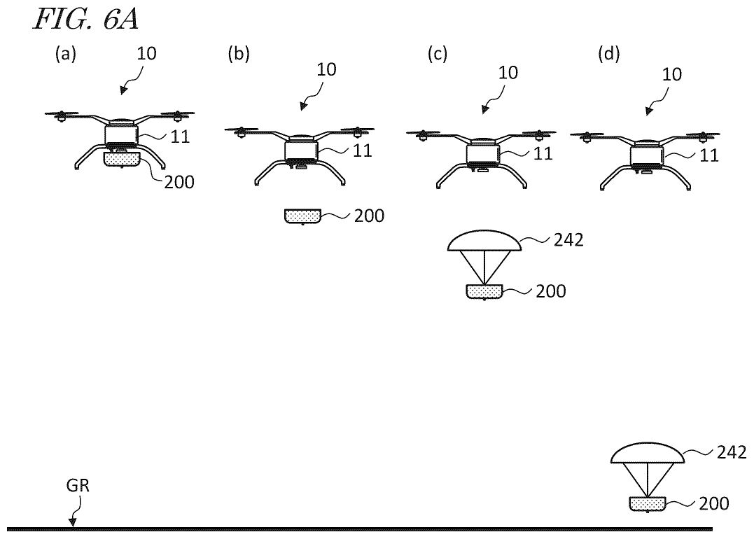

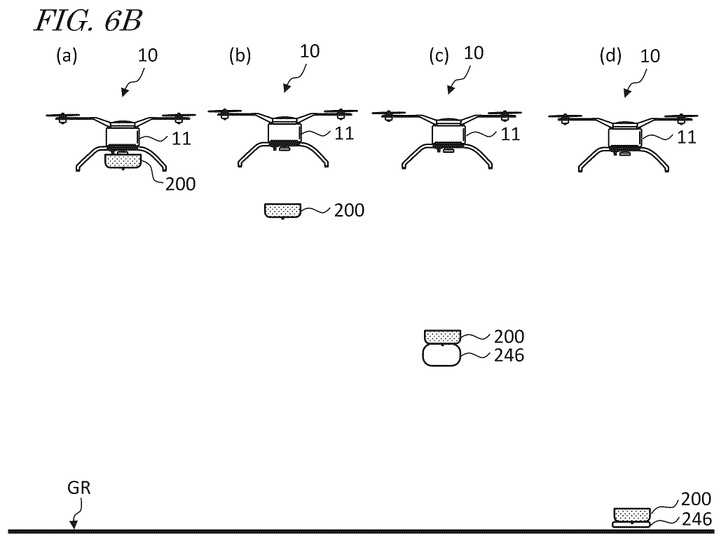

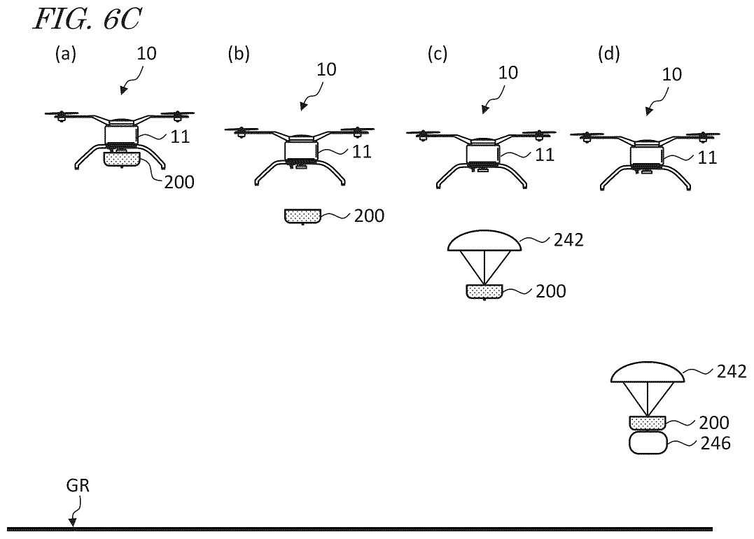

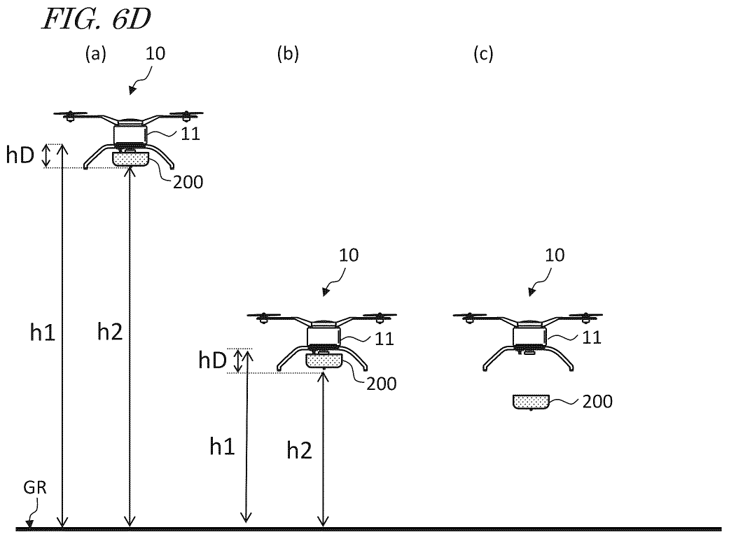

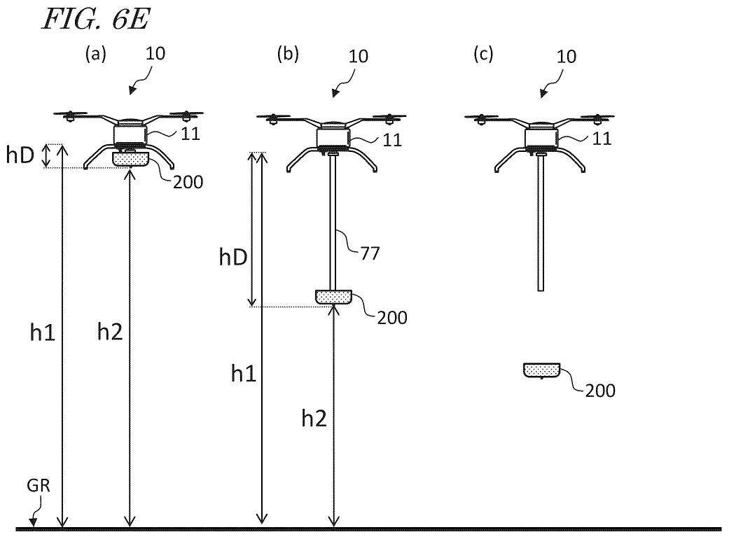

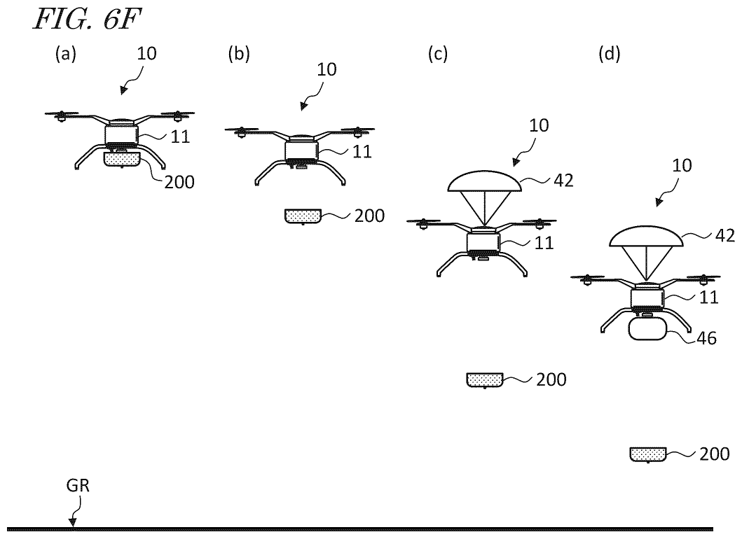

When it is determined to release the connection between the implement 200 and the body 11, the controller 4a determines the timing to activate the parachute 242 and the airbag 246 at step S30. Specific examples of the timing to activate the parachute 242 and the airbag 246 when releasing the connection between the implement 200 and the body 11 will be described later with reference to FIGS. 6A to 6F. At step S30, the controller 4a may decide whether to activate the parachute 242 based on the height of the body 11 from the ground and the height of the implement 200 from the ground. The controller 4a may determine whether the height of the implement 200 from the ground is equal to or greater than a predetermined value, and decide to activate the parachute 242 if the height of the implement 200 from the ground is determined to be equal to or greater than the predetermined value.

At step S32, the controller 4a activates the parachute 242 and/or the airbag 246. The controller 4a provides control signals to the parachute activation device 241 and the airbag activation device 245 so that the parachute 242 and the airbag 246 are activated at the determined timing.

At step S34, the controller 4a releases the connection between the implement 200 and the body 11 by controlling the connection mechanism 210.

The order of the flowchart in FIG. 4B may be rearranged as appropriate. The controller 4a may be configured or programmed to execute multiple steps simultaneously. For example, steps S30, S32, and S34 may be executed simultaneously.

Another example of the operation of the controller 4a will be explained with reference to FIG. 4C. FIG. 4C is a flowchart showing an example of the operation of the controller 4a of the multicopter 10 shown in FIG. 2A, 2B, or 2C.

While the multicopter 10 is flying with the implement 200 connected to the body 11, the controller 4a determines at step S40 whether any abnormality (for example, failure of a rotor 2, damage to a rotor 2, failure of a rotation driver that controls the rotation of a rotor 2, etc.) has occurred. Step S40 may be performed in the same manner as step S10 in FIG. 4A. If it is determined that an abnormality has occurred (in the case of “Yes”), the process proceeds to step S42.

At step S42, the controller 4a determines whether to release the connection between the implement 200 and the body 11. Step S42 may be performed in the same manner as step S28 in FIG. 4B. If it is determined to release the connection between the implement 200 and the body 11 (in the case of “Yes”), the controller 4a releases the connection between the implement 200 and the body 11 by controlling the connection mechanism 210 at step S44.

The flowcharts shown in FIGS. 4A, 4B, and 4C are examples of the operation of the controller 4a and may be modified as appropriate.

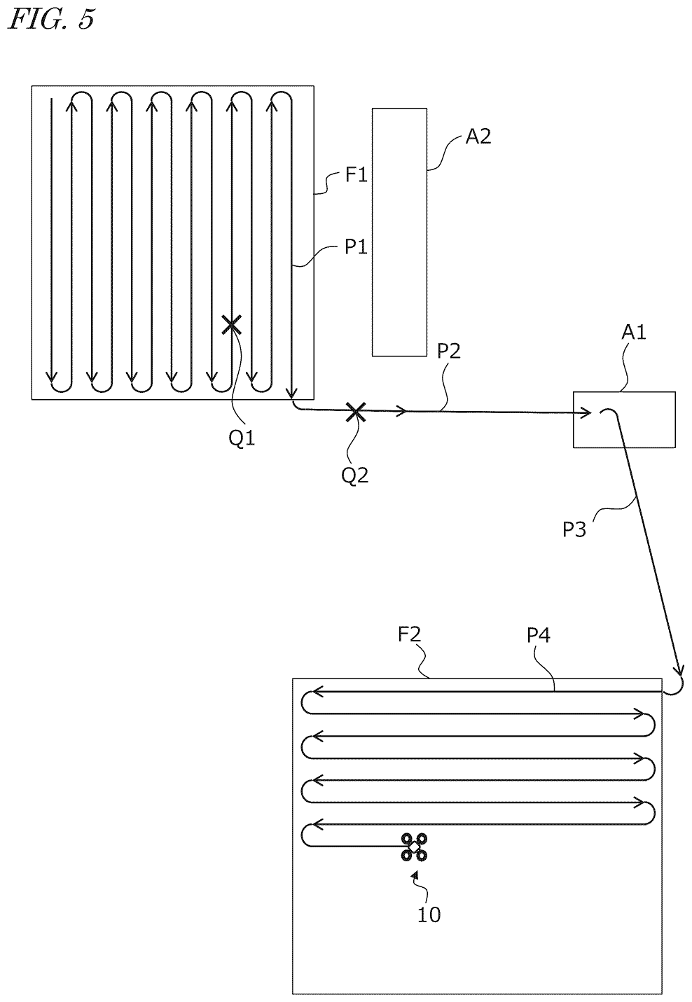

FIG. 5 is a plan view schematically showing the flight path of the multicopter 10 according to the present example embodiment. As will be explained with reference to FIG. 5, the controller 4a is configured or programmed to control the flight of the multicopter 10 can release the connection between the implement 200 and the body 11 (that is, detach the implement 200 from the body 11) during flight of the multicopter 10. The detachment of the implement 200 may be performed as a countermeasure in case of an abnormality (for example, failure of a rotor 2, damage to a rotor 2, failure of a rotation driver that controls the rotation of a rotor 2, etc.) occurring while the multicopter 10 is flying with the implement 200 connected, as explained with reference to FIG. 5.

In the example shown in FIG. 5, the multicopter 10 moves along flight paths P1, P2, P3, and P4, automatically or autonomously, or by remote control.

In a field F1, the flight path P1 meanders regularly in order to perform agricultural work (ground work) such as spraying agricultural chemicals or fertilizers while flying. The implement 200 connected to the body 11 of the multicopter 10 performs agricultural work. Even when the implement 200 connected to the body 11 of the multicopter 10 performs agricultural work, it may be expressed as “the multicopter 10 performs agricultural work”. The multicopter 10 performs necessary work (ground work) on areas where crops exist or on the ground itself in the field F1. To perform such work, the flight altitude of the multicopter 10 on the flight path P1 may be controlled at a preferred level within the range of, for example, 0.1 m or more and 5 m or less.

After completing work in the field F1, the multicopter 10 moves to an area A1 via the flight path P2. For simplicity, the length of the flight path P2 is shown as short in the figure, but the actual length of the flight path P2 may be, for example, several hundred meters or more. The flight altitude of the multicopter 10 moving along the flight path P2 is higher than the flight altitude of the multicopter 10 on the flight path P1 within the field F1, for example, 30 m or more and 150 m or less.

In the area A1, the multicopter 100 may, for example, descend and land, and operations such as replenishment of agricultural materials, charging of the multicopter 10, or refueling may be performed. The multicopter 10 that takes off from the area A1 moves to a field F2 via the flight path P3. Upon reaching the field F2, the multicopter 10 performs ground work along the flight path P4.

For example, when the controller 4a detects an abnormality of the rotor 2 at position Q1 in the middle of the flight path P1 within the field F1, the multicopter 10 may, for example, release the connection between the implement 200 and the body 11 at that point (that is, within the field F1). Alternatively, if the multicopter 10 is able to move, it may move to an area of the field F1 where agricultural work by the implement 200 has not yet been performed, and then release the connection between the implement 200 and the body 11. After detaching the implement 200, the multicopter 10 may move to the nearest possible landing area A2. In this case, the controller 4a changes the flight path from the planned flight path P1 and creates a flight path leading to the area A2.

When the controller 4a detects an abnormality of the rotor 2 at a point Q2 on the flight path P2 between the field F1 and the field F2, the multicopter 10 may, for example, release the connection between the implement 200 and the body 11. If the multicopter 10 is able to move, it may move to the nearest area more suitable for dropping the implement 200 (for example, the area A2 or the field F1 owned by the user) and then release the connection between the implement 200 and the body 11. In this case, the controller 4a changes the flight path from the planned flight path P2 and creates a flight path leading to the area A2 or the field F1. If the area A1 is an area where the implement 200 can be detached from the body 11, the multicopter 10 may move to the area A1 without changing the flight path P2 and detach the implement 200 from the body 11 above the area A1.

Areas where the implement 200 can be dropped may be, for example, previously stored in the storage device 37 (see FIG. 8) included in the controller 4a by the user. When detecting an abnormality of the rotor 2 during flight, the controller 4a may select the closest area from among the areas where the implement 200 can be dropped, and move the multicopter 10 to the selected area.

Since the flight altitude of the multicopter 10 on the flight path P2 is higher than the flight altitude of the multicopter 10 on the flight path P1 within the field F1, it is preferable to deploy the parachute 42 when an abnormality is detected on the flight path P2.

FIGS. 6A, 6B, 6C, 6D, 6E, and 6F are diagrams schematically showing how the multicopter 10, which is flying with the implement 200 connected to the body 11, releases the connection between the implement 200 and the body 11 during flight. The sequence is shown from left to right in the figure, that is, in the order of (a), (b), (c), and (d) along the timeline.

In the examples of FIGS. 6A to 6E, as shown in the configuration of FIG. 3B, the multicopter 10 has a parachute 242 connected to the implement 200 and an airbag 246 provided on the implement 200. By activating the parachute 242 and/or the airbag 246 when the controller 4a detaches the implement 200 from the body 11, it is possible to mitigate the impact when the implement 200 collides with the ground.

In the example of FIG. 6A, the controller 4a deploys the parachute 242 when releasing the connection between the implement 200 and the body 11 during flight. In the illustrated example, the parachute 242 is deployed (FIG. 6A (c)) after the connection between the implement 200 and the body 11 is released (FIG. 6A (b)), but the order of the timing of releasing the connection between the implement 200 and the body 11 and the timing of deploying the parachute 242 is not particularly limited.

The controller 4a may, for example, deploy the parachute 42 only when the height of the implement 200 from the ground GR is equal to or greater than a predetermined value, and may not deploy the parachute 42 when the height of the implement 200 from the ground GR is less than the predetermined value. The controller 4a can calculate the height of the implement 200 from the ground GR using sensor data output from an altitude sensor included in the sensor group 4b. Information indicating the height difference between the altitude sensor mounted on the body 11 of the multicopter 10 and the implement 200 is stored in the storage device 37 of the controller 4a, for example, by the user. The controller 4a can calculate the height of the implement 200 from the ground GR using, for example, the information indicating the height difference between the altitude sensor and the implement 200, and the sensor data output from the altitude sensor.

In the example of FIG. 6B, the controller 4a activates the airbag 246 when releasing the connection between the implement 200 and the body 11 during flight. The airbag 246 is, for example, stored in an airbag storage portion provided at the lower portion of the implement 200. The airbag 246 is, for example, stored so as to be positioned at the lower portion of the implement 200 when activated. The airbag 246 may have a configuration that becomes smaller (deflates) when it detects impact upon collision with the ground GR, as shown in FIG. 6B (d).

As shown in the example of FIG. 6C, both the parachute 242 and the airbag 246 may be activated. By using both the parachute 242 connected to the implement 200 and the airbag 246 provided on the implement 200, the impact when the implement 200 collides with the ground GR can be further mitigated. The controller 4a may be configured or programmed to control the parachute 242 and the airbag 246 such that the airbag 246 is activated (FIG. 6C (d)) after the parachute 242 is deployed (FIG. 6C (c)).

In the examples shown in FIGS. 6D and 6E, the controller 4a lowers the height h2 of the implement 200 from the ground GR (FIGS. 6D and 6E (b)) before releasing the connection between the implement 200 and the body 11 during flight (FIGS. 6D and 6E (c)). By reducing the height h2 of the implement 200 from the ground GR (that is, bringing the implement 200 closer to the ground GR) when releasing the connection between the implement 200 and the body 11, the impact when the implement 200 collides with the ground GR can be reduced. For example, as shown in the example of FIG. 6D, the controller 4a may lower both the height h1 of the body 11 from the ground GR and the height h2 of the implement 200 from the ground GR before releasing the connection between the implement 200 and the body 11, where the difference hD between the height h1 of the body 11 from the ground GR and the height h2 of the implement 200 from the ground GR does not change. Alternatively, as shown in the example of FIG. 6E, the height h2 of the implement 200 from the ground GR may be reduced by increasing the difference hD between the height h1 of the body 11 from the ground GR and the height h2 of the implement 200 from the ground GR (that is, the distance between the implement 200 and the body 11). For example, the length of the suspension rope (rope) 77 suspending the implement 200 from the body 11 may be increased while maintaining the altitude of the body 11.

In the example of FIG. 6F, as in the configuration example shown in FIG. 3A, the multicopter 10 has a parachute 42 connected to the body 11 (here, the main body 4) and an airbag 46 provided on the body 11 (here, the main body 4). In the example of FIG. 6F, the controller 4a deploys the parachute 42 when releasing the connection between the implement 200 and the body 11 during flight. In the illustrated example, the parachute 42 is deployed (FIG. 6F (c)) after the connection between the implement 200 and the body 11 is released (FIG. 6F (b)), but the order of the timing of releasing the connection between the implement 200 and the body 11 and the timing of deploying the parachute 42 is not particularly limited. Also, the controller 4a activates the airbag 46 when releasing the connection between the implement 200 and the body 11 during flight. The controller 4a may control the parachute 42 and the airbag 46 such that the airbag 46 is activated (FIG. 6F (d)) after the parachute 42 is deployed (FIG. 6F (c)). The airbag 46 is, for example, stored in an airbag storage portion provided at the lower portion of the body 11. The airbag 46 is, for example, stored so as to be positioned at the lower portion of the body 11 when activated.

The examples of FIGS. 6A to 6F can be combined as appropriate.

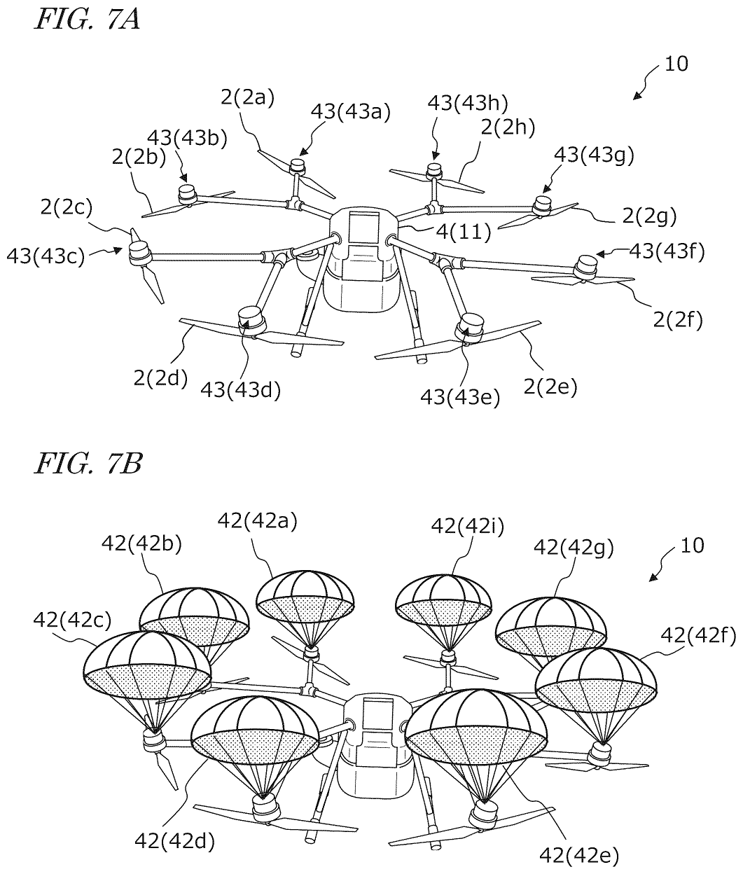

FIGS. 7A and 7B are perspective views schematically showing other examples of the configuration of the multicopter 10.

In the examples shown in FIGS. 7A and 7B, the multicopter 10 includes a plurality of parachutes 42, each provided corresponding to one of the plurality of rotors 2. FIG. 7A schematically shows a state where the parachutes 42 are not activated (deployed), and FIG. 7B schematically shows a state where all of the plurality of parachutes 42 are deployed. For simplicity, the illustration of the implement is omitted in FIGS. 7A and 7B. Parachutes 42a, 42b, 42c, 42d, 42e, 42f, 42g, and 42h are respectively provided corresponding to rotors 2a, 2b, 2c, 2d, 2e, 2f, 2g, and 2h of the multicopter 10. Each of the plurality of parachutes 42 (42a to 42h) is stored in a parachute storage portion 43 (43a to 43h) provided above the corresponding rotor 2 (2a to 2h). FIGS. 7A and 7B show an example of an octocopter with 8 rotors, but the configuration of the multicopter 10 is not limited to this and may be applied to, for example, a quadcopter.

In the example of FIGS. 7A and 7B, when the controller 4a detects an abnormality in any of the plurality of rotors 2 during flight, it stops the rotor 2 where the abnormality was detected and deploys the parachute 42 corresponding to the rotor 2 where the abnormality was detected from among the plurality of parachutes 42. For example, when an abnormality is detected in the rotor 2a, the rotor 2a is stopped and the parachute 42a is deployed. When only some of the plurality of rotors 2 are stopped, it may not be possible to accurately control the attitude of the multicopter 10, and the multicopter 10 may tilt. In contrast, by deploying the parachute 42 corresponding to the stopped rotor 2, it is possible to maintain balance with the other rotors 2 and maintain the attitude of the multicopter 10 horizontal. The controller 4a may also lower the rotation speed of the other rotors 2 as necessary.

Alternatively, when the controller 4a detects an abnormality in any of the plurality of rotors 2 during flight, it may stop both the rotor 2 where the abnormality was detected and the rotor 2 positioned on the diagonal line of the rotor where the abnormality was detected. For example, when an abnormality is detected in rotor 2a, both rotor 2a and rotor 2e are stopped. The controller 4a may further deploy the parachutes 42 corresponding to the stopped rotors 2.

When the multicopter 10 includes the fourth rotation driver 3D shown in FIG. 1A, a part of the plurality of rotors 2 is rotated by the motors 14, and the other rotors 2 are rotated by the internal combustion engine 7a. In such a case, when the controller 4a detects, during flight, an abnormality in any of the rotors 2 that are rotated by the motors 14 among the plurality of rotors 2, it may stop all rotors 2 that are rotated by the motors 14. The diameter of one or more rotors 2 rotated by the internal combustion engine 7a may be larger than the diameter of the other rotors 2 rotated by the motors 14. The one or more rotors 2 rotated by the internal combustion engine 7a may be called main rotors, and the other rotors 2 rotated by the motors 14 may be called sub-rotors. In such a case, the main rotors are mainly used to generate thrust, and the sub-rotors are used to generate thrust and attitude control.

The controller 4a in the present example embodiment of the present disclosure may be realized by a digital computer system configured or programmed to execute each process described with reference to FIGS. 4A and 4B.

FIG. 8 is a block diagram showing an example of the hardware configuration of the controller 4a. The controller 4a includes a processor 34, ROM (Read Only Memory) 35, RAM (Random Access Memory) 36, storage device 37, and communication I/F 38. These components are interconnected via a bus 39.

The processor 34 is one or more semiconductor integrated circuits, also referred to as a central processing unit (CPU) or microprocessor. The processor 34 sequentially executes computer programs stored in ROM 35 to implement the aforementioned processing. The term processor 34 is broadly interpreted to encompass devices such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Part of the plurality of collections may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 4a and other electronic components or electronic control units (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, and various sensor data acquired by the multicopter 10 during flight.

Note that, as mentioned earlier, the controller 4a may be configured or programmed to include, for example, a flight controller such as a flight controller and a higher-level computer (companion computer). The companion computer may execute each of the processes shown in FIGS. 4A and 4B and provide commands regarding flight to the flight controller based on the results of those processes.

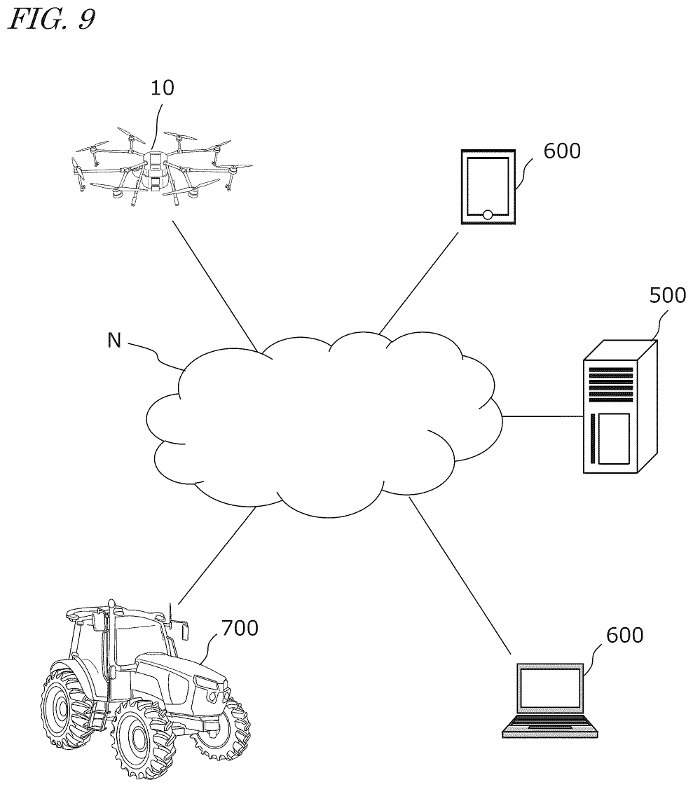

FIG. 9 is a schematic diagram showing an example of a system including the multicopter 10. One or more servers (computers) 500 or terminal devices (including mobile and stationary types) 600 connected to the communication device 4c of the multicopter 10 via a communication network N may realize some or all of the functions of the controller 4a. Agricultural machines 700 such as tractors may also be connected to the communication network N, and communication may be performed between the multicopter 10 and the agricultural machines 700. Through the communication network N, some of the data used to process by the controller 4a and control signals for the multicopter 10 may be provided to the multicopter 10 from the agricultural machines 700.

Unmanned aerial vehicles according to example embodiments of the present disclosure may be widely utilized not only for aerial photography, surveying, logistics, and agricultural chemical spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising:
a plurality of rotors to cause the unmanned aerial vehicle to fly with a ground work machine connected to a body;
a controller configured or programmed to control flight of the unmanned aerial vehicle;
at least one parachute connected to the body or the ground work machine; and
at least one airbag provided on the body or the ground work machine.

2. The unmanned aerial vehicle according to claim 1, wherein the controller is configured or programmed to release a connection between the ground work machine and the body during flight.

3. The unmanned aerial vehicle according to claim 2, wherein the controller is configured or programmed to lower a height of the ground work machine from the ground before releasing the connection between the ground work machine and the body during flight.

4. The unmanned aerial vehicle according to claim 3, wherein the controller is configured or programmed to increase a distance between the ground work machine and the body before releasing the connection between the ground work machine and the body during flight.

5. The unmanned aerial vehicle according to claim 2, wherein the controller is configured or programmed to release the connection between the ground work machine and the body when detecting an abnormality of the plurality of rotors during flight.

6. The unmanned aerial vehicle according to claim 5, wherein
the controller is configured or programmed to determine a total thrust that is a sum of thrust to be generated by the plurality of rotors during flight; and
the controller is configured or programmed to release the connection between the ground work machine and the body during flight when the determined total thrust cannot be obtained by the plurality of rotors.

7. The unmanned aerial vehicle according to claim 5, wherein the controller, when detecting an abnormality of the plurality of rotors during flight over a field, is configured or programmed to move the unmanned aerial vehicle over an area of the field where work has not yet been performed, and release the connection between the ground work machine and the body over the area.

8. The unmanned aerial vehicle according to claim 7, wherein the work includes agricultural work by the ground work machine.

9. The unmanned aerial vehicle according to claim 2, wherein
the at least one parachute includes a first parachute connected to the ground work machine; and
the controller is configured or programmed to deploy the first parachute when releasing the connection between the ground work machine and the body during flight.

10. The unmanned aerial vehicle according to claim 9, wherein the controller, when releasing the connection between the ground work machine and the body during flight, is configured or programmed to:
deploy the first parachute when a height of the ground work machine from the ground is equal to or greater than a predetermined value, and
not deploy the first parachute when a height of the ground work machine from the ground is less than the predetermined value.

11. The unmanned aerial vehicle according to claim 1, wherein the at least one airbag includes a first airbag provided on the ground work machine.

12. The unmanned aerial vehicle according to claim 2, wherein
the at least one airbag includes a first airbag provided on the ground work machine; and
the controller is configured or programmed to activate the first airbag when releasing the connection between the ground work machine and the body during flight.

13. The unmanned aerial vehicle according to claim 12, wherein
the at least one parachute includes a first parachute connected to the ground work machine;
the controller is configured or programmed to deploy the first parachute when releasing the connection between the ground work machine and the body during flight;
the at least one airbag includes a first airbag provided on the ground work machine; and
the controller is configured or programmed to activate the first airbag after deploying the first parachute.

14. The unmanned aerial vehicle according to claim 1, wherein the at least one airbag includes a second airbag provided at a lower portion of the body.

15. The unmanned aerial vehicle according to claim 1, wherein the controller, when detecting an abnormality in any of a plurality of first rotors included in the plurality of rotors during flight, is configured or programmed to stop all of the plurality of first rotors.

16. The unmanned aerial vehicle according to claim 1, wherein
the at least one parachute includes a plurality of second parachutes each provided corresponding to any of a plurality of first rotors included in the plurality of rotors; and
the controller, when detecting an abnormality in any of the plurality of first rotors during flight, is configured or programmed to stop the first rotor where the abnormality was detected and deploy the second parachute corresponding to the first rotor where the abnormality was detected from among the plurality of second parachutes.

17. The unmanned aerial vehicle according to claim 1, wherein the controller, when detecting an abnormality in any of a plurality of first rotors included in the plurality of rotors during flight, is configured or programmed to stop both the first rotor where the abnormality was detected and the first rotor positioned on a diagonal line of the first rotor where the abnormality was detected.

18. The unmanned aerial vehicle according to claim 15, wherein the controller is configured or programmed to control an attitude of the unmanned aerial vehicle by controlling rotation of the plurality of first rotors during flight.

19. The unmanned aerial vehicle according to claim 15, further comprising:
a first rotation driver to drive the plurality of first rotors; and
a second rotation driver to drive at least one second rotor included in the plurality of rotors; wherein
the first rotation driver includes a plurality of electric motors that respectively drive the plurality of first rotors; and
the second rotation driver includes an internal combustion engine.

20. An unmanned aerial vehicle comprising:
a plurality of rotors to cause the unmanned aerial vehicle to fly with a ground work machine connected to a body;
a controller configured or programmed to control flight of the unmanned aerial vehicle; wherein
the controller is configured or programmed to release a connection between the ground work machine and the body when detecting an abnormality of the plurality of rotors during flight.

21. The unmanned aerial vehicle according to claim 20, wherein the controller, when detecting an abnormality of the plurality of rotors during flight over a field, is configured or programmed to move the unmanned aerial vehicle over an area of the field where work has not yet been performed, and release the connection between the ground work machine and the body over the area.
